(19) United States
(12) Patent Application Publication
(10) Pub. No.: US 2007/0076734 A1
(43) Pub. Date: Apr. 5, 2007

(54) Allocating resources to logical states

(75) Inventors: Raveendra Muniyappa, Bangalore (IN); Kannan Babu Ramia, Bangalore (IN)

Correspondence Address: RYDER IP LAW;C/O INTELLEVATE, P. O. BOX 52050, MINNEAPOLIS, MN, 55402, US

(73) Assignee: Intel Corporation

(21) Appl. No.: 11/240,342

(22) Filed: Sep. 30, 2005

(51) Int. Cl. H04L 12/56

(52) U.S. Cl. 370/412

(57) ABSTRACT

In some embodiments a method is disclosed. The method includes allocating a first set of threads for a first logical state and a second set of threads for a second logical state. The method further includes associating a first physical port with the first logical state and a second physical port with the second logical state. The associating assigns the first set of threads to the first physical port and the second set of threads to the second physical port. Other embodiments are otherwise disclosed herein.

### BACKGROUND

Store-and-forward devices (e.g., routers, firewalls) receive data (e.g., packets), process the data and transmit the data. The processing may be simple or complex. The processing may include routing, manipulation, and computation. Network processors may be used in the store-and-forward devices to process the packets. The network processors can receive and process large amounts of data. The network processors may include multiple microblocks for receiving, processing, scheduling and transmitting the data. The microblocks may process the data in parallel, in a pipeline, or a combination thereof.

A microblock within the network processor may be responsible for receiving and reassembling the data received from external sources over physical ports. In some network applications multiple physical ports are used to provide reliable and uninterrupted network services. For example, a first physical port may be used to carry network services such as voice and/or data (e.g., active port) while a second physical port may be reserved as a standby or a fallback from the active port (e.g., standby port, fallback port). The standby port may process control traffic. The control traffic is likely a small percentage of the traffic associated with the active port (e.g., 10%). In order to handle the active traffic a plurality of receive and reassemble threads may be allocated to the physical port receiving the active traffic while a single receive/reassemble thread is likely sufficient for the physical port receiving the control traffic.

When a physical port handling the active traffic experiences an outage or degradation, a switch-over may be performed so that the network traffic is forwarded via the physical port previously providing the control traffic and the control traffic is forwarded via the physical port previously providing the active traffic (if possible). In addition to switching the physical ports forwarding the data, the functionality (threads) associated with each physical port within the network processor will need to be reallocated. Reallocating the threads requires a significant amount of network processor resources.

In alternative implementation the threads allocated to each physical port may be fixed to receive data at a maximum rate. When a switch-over happens the threads allocated to each physical port remain the same. However, the physical port receiving the control traffic is only receiving a fraction of the data that the physical port receiving active data is receiving. Accordingly, the number of threads (resources) associated with the physical port receiving the control traffic is wasted both before and after a switch-over.

### BRIEF DESCRIPTION OF THE DRAWINGS

The features and advantages of the various embodiments will become apparent from the following detailed description in which:

FIG. 1 illustrates an example receive implementation of a network processor having sets of threads associated with physical ports, according to one embodiment;

FIG.2 illustrates an example receive implementation of the network processor of FIG. 1 after a switch-over, according to one embodiment;

FIG. 3 illustrates an example receive implementation of a network processor having sets of threads associated with logical ports, according to one embodiment;

FIG. 4 illustrates an example receive implementation of the network processor of FIG. 3 during a switch-over, according to one embodiment;

FIG. 5 illustrates an example receive implementation of the network processor of FIG. 3 after a switch-over, according to one embodiment.

### DETAILED DESCRIPTION

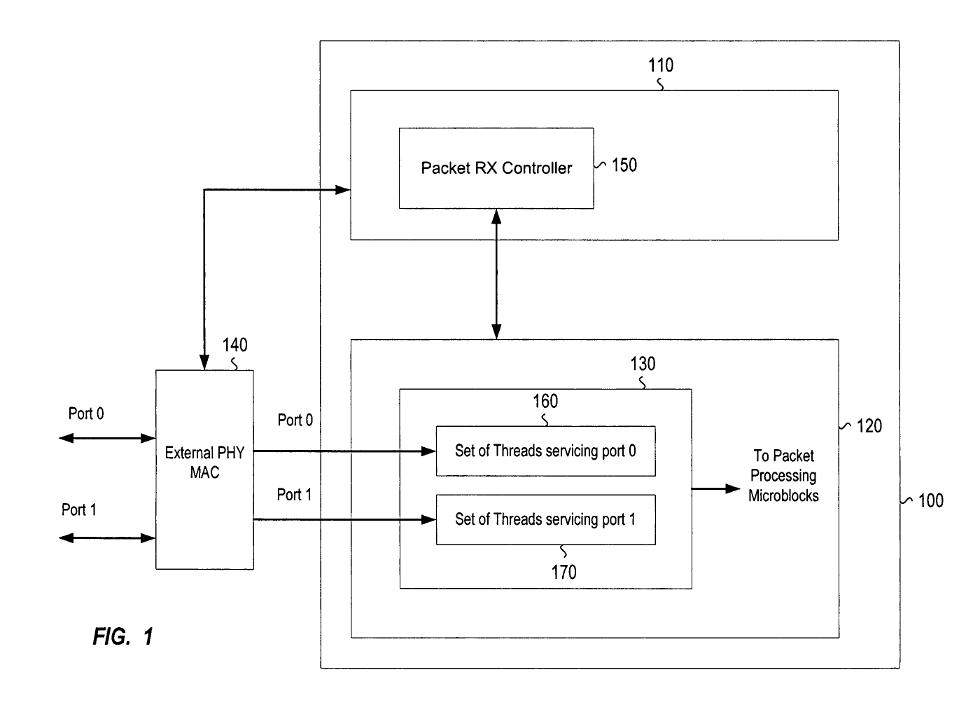

FIG. 1 illustrates an example receive implementation of a network processor 100. The network processor 100 may include a control processor 110 and a plurality of programmable data processors (microengines) 120 (only one illustrated for ease). The control processor 110 may be used to monitor and control the operation of the network processor 100. The mircroengines 120 may be programmed to perform various functions related to receiving, processing, scheduling, and transmitting data (e.g., packets). The various functions performed by the microengines 120 may be programmed using different software modules (microblocks) 130 (only a packet receive microblock 130 is illustrated). The packet receive microblock 130 defines how the packets are received from external sources and reassembled. The reassembled packets may be forwarded from the packet receive microblock 130 to packet processing microblocks (not illustrated) contained within the network processor 100.

The packets coming from external sources may first be received by an external physical MAC 140. The packets being received may be for network services (e.g., voice, video, data) or may be for supplemental services (e.g., control). The packets may be transmitted using any number of protocols including, but not limited to, Ethernet (e.g., Gigabit, 10 Base T), Fibre channel, Synchronous Optical Network (SONET), Synchronous Digital Hierarchy (SDH), Utopia, and HSS. The external physical MAC 140 would have the appropriate interface to receive the specific type of data. It should be noted that only a single packet receive microengine 130 and a single external physical MAC 140 are illustrated for ease. The network processor 100 could include a plurality of packet receive microblocks 130 to receive packets from multiple external sources via an associated plurality of external physical MACs 140.

The external physical MAC 140 may receive the data via one or more physical ports. As illustrated, the external physical MAC 140 receives data via a pair of ports (port 0 and port 1). The ports may be redundant where one handles the data (active port) and the other is in a standby mode (standby port) in case the active port fails or is degraded. In addition to acting as a standby, the standby port may receive control data. The external physical MAC 140 may forward the data to the network processor 100 via a bus having a plurality ports (port 0 and port 1). One of the ports (e.g., port 0) may be the active port and transmit the network traffic (data, voice, video) while the other port (e.g., port 1) may be the standby port and transmit the control data.

The control processor 110 may be coupled to the external physical MAC 140. The control processor 110 may receive control data from the external physical MAC 140 and detect an outage or degradation of a physical port. The control processor 110 may include a packet receive controller 150 to determine and maintain a thread allocation for the physical ports (number of threads associated with each physical port). The number of threads allocated to a physical port receiving active data (active port) may be calculated based on the receive rate of the data. For example, a physical port receiving active packets (e.g., voice, video, data) from a 1 gigabyte Ethernet MAC may be allocated three receive/reassemble threads to process (receive/reassemble) the data at that speed. A physical port receiving control packets likely only needs a single receive/reassemble thread.

The packet receive controller 150 may forward the thread allocation to the packet receive microblock 130, where each physical port will be associated with a set of threads. As illustrated, the packet receive microblock includes a set of threads servicing port 0 160 and a set of threads servicing port 1 170. If physical port 0 is receiving the active traffic and physical port 1 is receiving the standby traffic, the set of threads servicing port 0 160 may include 3 receive/reassemble threads and the set of threads servicing port 1 170 may include 1 receive/reassemble thread.

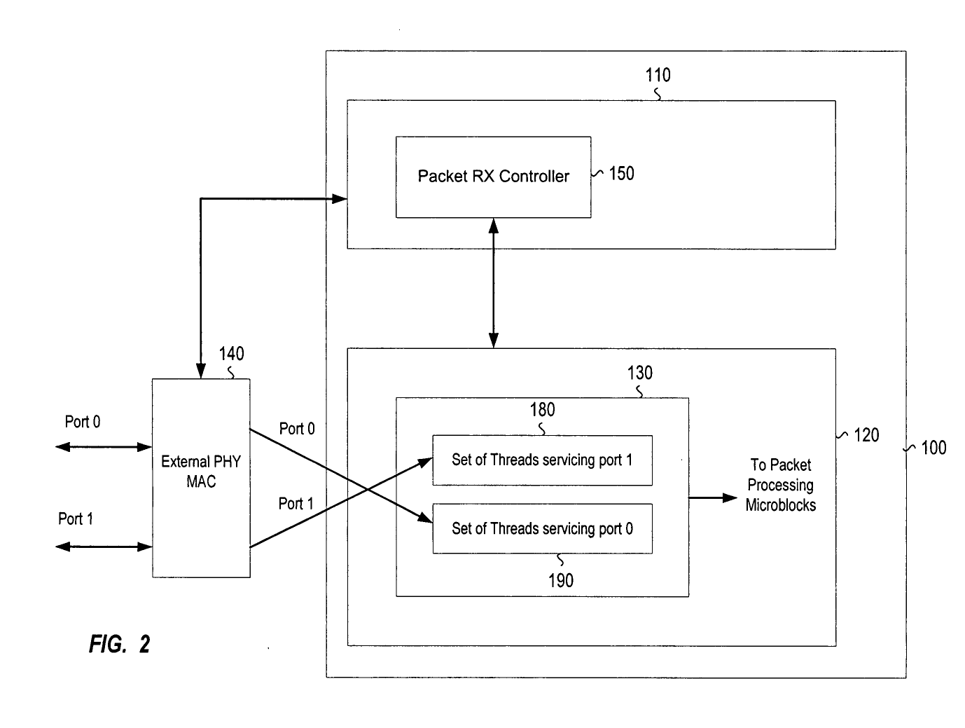

If the control processor 110 detects a failure of the active port (port 0) it may initiate a switch-over. FIG. 2 illustrates an example receive implementation of the network processor 100 after a switch-over. The switch-over entails swapping the physical ports on which the data is forwarded from the physical MAC 140 and updating the threads allocated to the physical ports (reallocation).

The data previously forwarded on physical port 0 (e.g., active data) is now forwarded on physical port 1 and the data previously forward on physical port 1 (e.g., control data) is now forwarded on physical port 0. As the rate at which data is received is different for each of the physical ports a thread re-allocation is performed so that an appropriate number of threads are associated with the physical ports. For example, if physical port 1 is now receiving the active data and physical port 0 is receiving the control data, a set of threads servicing port 1 180 may now be allocated three threads and a set of threads servicing port 0 190 may now be allocated a single thread. For ease of understanding, the switch-over is illustrated by crossing the connections between the external physical MAC 140 and the packet receive microblock 130. It should be noted that connections are logically switched and not physically switched.

A challenge in network processor base applications is to achieve the switch-over with minimal processing overheads and minimal set of resources. Reallocating the threads to the physical ports on a switch-over is processor intensive.

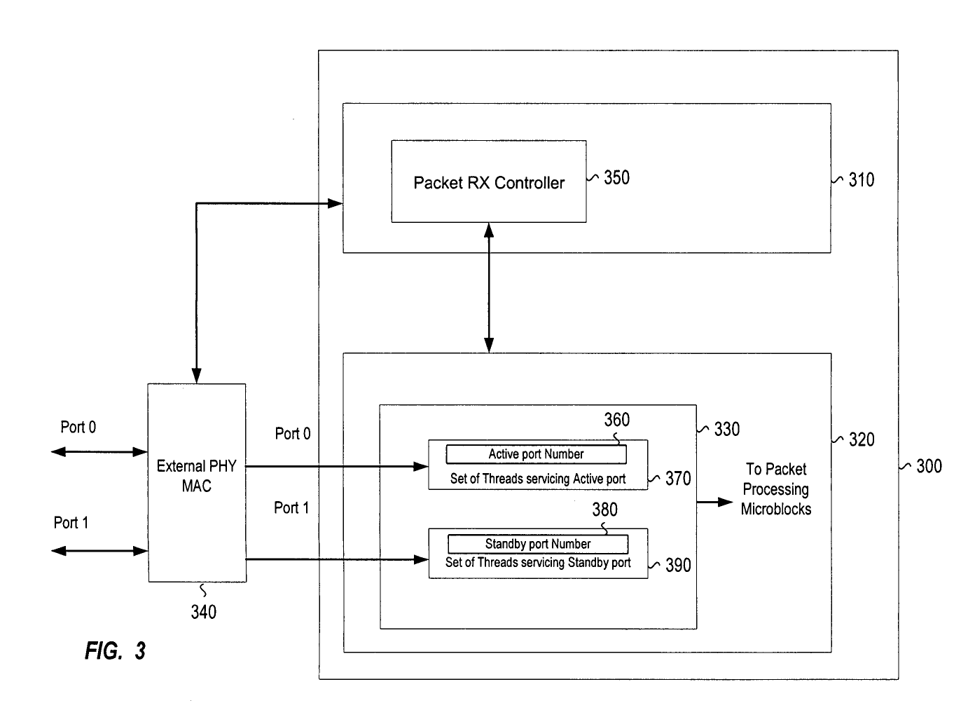

FIG. 3 illustrates an example receive implementation of a network processor 300. The network processor 300 may include a control processor 310 and a programmable data processor (microengine) 320. A packet receive software module (microblock) 330 defines how the packets from external sources are received and reassembled by the network processor 300. The packets coming from external sources may first be received by an external physical MAC 340. The control processor 310 may include a packet receive controller 350 to determine and maintain a thread allocation to the logical status (active, standby) of the ports. The number of threads allocated to active data (an active port) may be calculated based on the receive rate of the active data. The data rate associated with the logical states (active, standby) is unlikely to change, accordingly the allocation would be the same after a switch-over (no reallocation of threads to logical status required).

The packet receive controller 350 may also determine and maintain an association of the physical ports to the logical states. The association may include identifying a logical port type as one of the parameters of the physical port. The packet receive controller 350 may provide the association to the packet receive microblock 330. For example, the packet receive microblock 330 may include a register for each physical port that contains a logical port identification (number). According to one embodiment, the logical port identification may be a single digit, where a 0 represents port having an active state (an active port) and a 1 represents a port having a standby state (a standby port). Based on the logical port identification, the physical port is assigned an associated set of threads. If the physical port is assigned an active port number 360 a set of threads for servicing an active port 370 will be allocated. If the physical port is assigned a standby port number 380 a set of threads for servicing a standby port 390 will be allocated. As illustrated, physical port 0 is the active port and physical port 1 is the standby port.

If the control processor 310 detects a failure of the active port (port 0) it may initiate a switch-over. The switch-over entails swapping the physical ports on which the data is forwarded from the physical MAC 340 and updating the threads associated with the physical ports. Updating the threads for the physical ports requires that the logical port property be updated so that the associated set of threads is assigned.

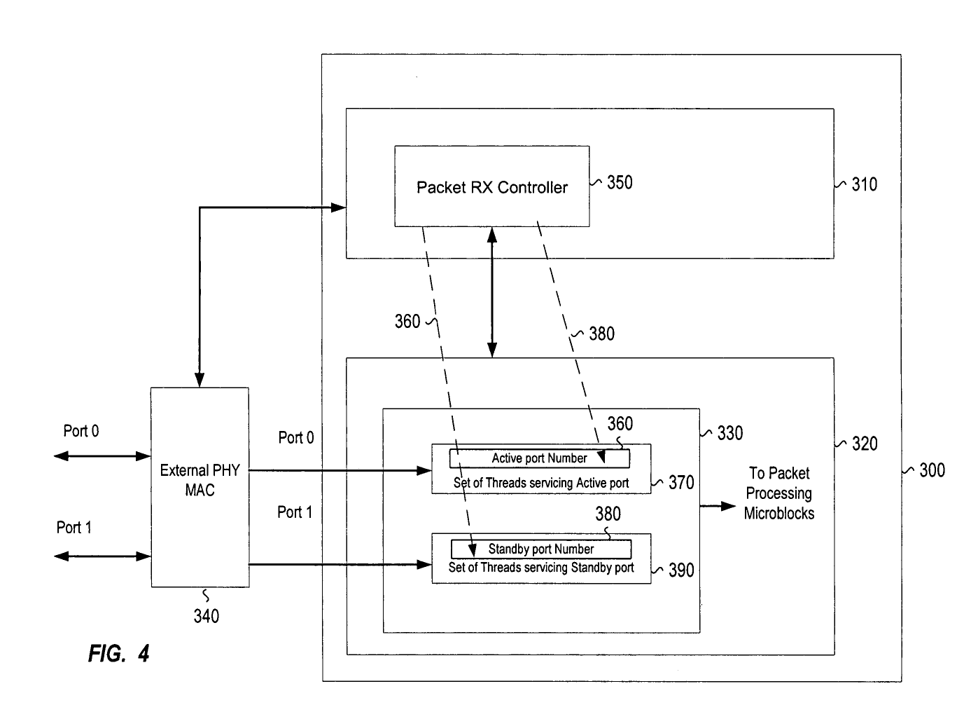

FIG. 4 illustrates an example receive implementation of the network processor 300 during a switch-over. The packet receive controller 350 updates the logical port identification for each physical port and forwards the new logical port identification to the packet receive microblock 330 (register for each physical port) along with a switch-over command. As illustrated, the packet receive controller 350 forwards a standby port number 380 to the register associated with physical port 0 and an active port number 360 to the register associated with physical port 1.

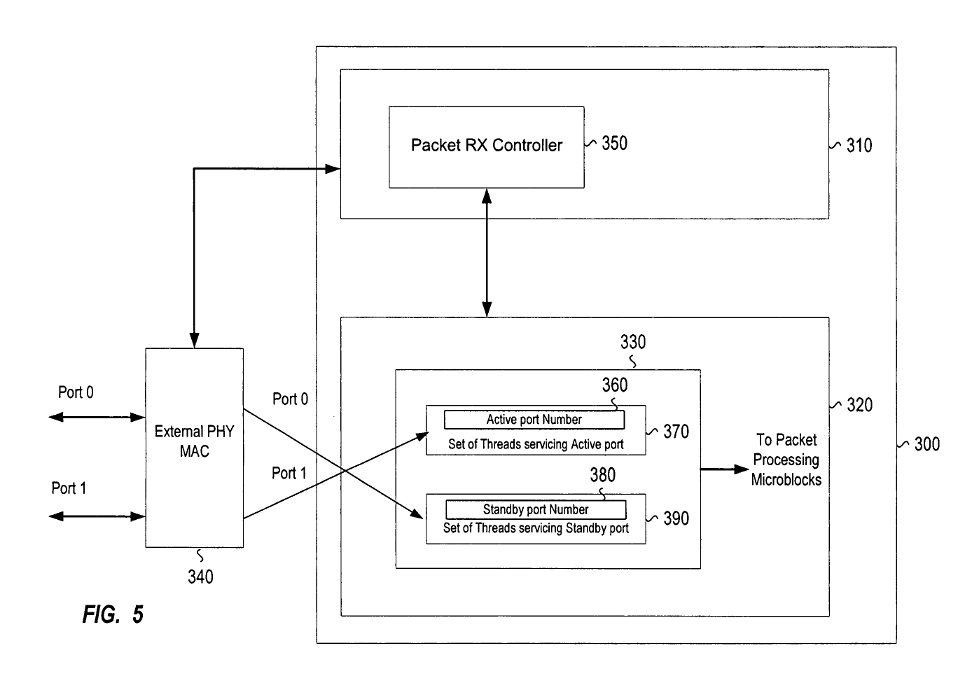

FIG. 5 illustrates an example receive implementation of the network processor 300 after the switch-over command. The data previously forwarded on physical port 0 (e.g., active data) is now forwarded on physical port 1 and the data previously forward on physical port 1 (e.g., control data) is now forwarded on physical port 0. The logical port identification associated with physical port 0 is the standby port number 380 so that the set of threads associated with physical port 0 is the set of threads servicing the standby port 390. The logical port identification associated with physical port 1 is the active port number 360 so that the set of threads associated with physical port 1 is the set of threads servicing the active port 370. For ease of understanding, the switch-over is illustrated by crossing the connections between the external physical MAC 340 and the packet receive microblock 330. It should be noted that connections are logically switched and not physically switched.

After the packets are received and reassembled by the packet receive microblock 330 they are forwarded to other microblocks or other microengines for processing, scheduling, and transmission. As the packets are being processed by the other microblocks or microengines, the packets may need to be queued. The packets may be queued in local memory or may be queued in external memory (e.g., DRAM).

The various embodiments discussed herein focused on network processors but are not limited thereto. Rather any device allocating resources to physical ports based on a logical status of the ports could utilize the embodiments discussed herein to update the resources applied to the physical ports upon detection of a failure.

The various embodiments described herein focused threads used to receive data from physical ports and to reassemble the data. The embodiments are not limited thereto. For example, the threads could be associated with transmitting data over physical ports.

Although the various embodiments have been illustrated by reference to specific embodiments, it will be apparent that various changes and modifications may be made. Reference to “one embodiment” or “an embodiment” means that a particular feature, structure, or characteristic described in connection with the embodiment is included in at least one embodiment. Thus, the appearances of the phrase “in one embodiment” or “in an embodiment” appearing in various places throughout the specification are not necessarily all referring to the same embodiment.

Different implementations may feature different combinations of hardware, firmware, and/or software. In one example, machine-readable instructions can be provided to a machine (e.g., an ASIC, special finction controller or processor, FPGA or other hardware device) from a form of machine-accessible medium. A machine-accessible medium may represent any mechanism that provides (i.e., stores and/or transmits) information in a form readable and/or accessible to the machine. For example, a machine-accessible medium may include: ROM; RAM; magnetic disk storage media; optical storage media; flash memory devices; electrical, optical, acoustical or other form of propagated signals (e.g., carrier waves, infrared signals, digital signals); and the like.

The various embodiments are intended to be protected broadly within the spirit and scope of the appended claims.

What is claimed:

1. A method comprising:
allocating a first set of threads for a first logical state;
allocating a second set of threads for a second logical state; and
associating a first physical port with the first logical state and a second physical port with the second logical state, wherein said associating assigns the first set of threads to the first physical port and the second set of threads to the second physical port.

2. The method of claim 1, wherein said associating includes
forwarding a first logical state identification to a register associated with the first physical port; and
forwarding a second logical state identification to a register associated with the second physical port.

3. The method of claim 1, wherein the first logical state is active, the active state indicating active data flow, and wherein the first set of threads are used to receive and reassemble the data.

4. The method of claim 3, wherein number of threads in the first set of threads is based on receive rate of the data.

5. The method of claim 3, wherein the second logical state is standby, the standby state indicating no data flow currently, capable of active control signal flow, and reserved for active data flow upon failure, and wherein the second set of threads are used to receive and reassemble the control signals.

6. The method of claim 5, further comprising
detecting a fault in the first physical port;
associating the first physical port with the standby state and the second physical port with the active state, wherein said associating assigns the second set of threads to the first physical port and the first set of threads to the second physical port; and
issuing a switch-over command.

7. The method of claim 6, wherein said associating includes
forwarding a standby state identification to a register associated with the first physical port;
forwarding an active state identification to a register associated with a second physical port.

8. A machine-accessible medium comprising content, which, when executed by a machine causes the machine to:
allocate a first set of threads to a logically active port, wherein number of threads in the first set of threads is based on receive rate of data;
allocate a second set of threads to a logical standby port;
associate a first physical port with the logically active port to assign the first set of threads to the first physical port, wherein the first set of threads are used to receive and reassemble data forwarded via the first physical port;
associate a second physical port with the logical standby port to assign the second set of threads to the second physical port, wherein the second set of threads are used to receive and reassemble control signals forwarded via the second physical port.

9. The machine-accessible medium of claim 8, wherein when executed by the machine further causes the machine to:
forward an active port identification to a register associated with the first physical port; and
forward a standby port identification to a register associated with the second physical port.

10. The machine-accessible medium of claim 8, wherein when executed by the machine further causes the machine to:
detect a fault in the first physical port;
associate the first physical port with the logical standby port to assign the second set of threads to the first physical port;
associate the second physical port with the logically active port to assign the second set of threads to the second physical port; and
issue a switch-over command.

11. The machine-accessible medium of claim 10, wherein when executed by the machine further causes the machine to:
forward a standby port identification to a register associated with the first physical port; and
forward an active port identification to a register associated with the second physical port.

12. A method comprising
receiving a logically active port identification at a first physical port, wherein the logically active port identification associates the first physical port with a first set of threads;
receiving a logical standby port identification at a second physical port, wherein the logical standby port identification associates the second physical port with a second set of threads;
utilizing the first set of threads to receive and reassemble data packets received from the first physical port; and
utilizing the second set of threads to receive and reassemble control packets received from the second physical port.

13. The method of claim 12, further comprising
storing the logically active port identification in a register associated with the first physical port; and
storing the logical standby port identification in a register associated with the second physical port.

14. The method of claim 12, further comprising
receiving, upon detection of a fault on the first physical port, the logically active port identification at the second physical port, the logical standby port identification at the first physical port, and a switch-over command; and
utilizing, upon completion of a switch-over, the first set of threads to receive and reassemble data packets received from the second physical port, and the second set of threads to receive and reassemble control packets received from the first physical port.

15. A machine-accessible medium comprising content, which, when executed by a machine causes the machine to:
receive a logically active port identification at a first physical port, wherein the logically active port identification associates the first physical port with a first set of threads;
receive a logical standby port identification at a second physical port, wherein the logical standby port identification associates the second physical port with a second set of threads;
utilize the first set of threads to receive and reassemble data packets received from the first physical port; and
utilize the second set of threads to receive and reassemble control packets received from the second physical port.

16. The machine-accessible medium of claim 15, wherein when executed by the machine further causes the machine to
store the logically active port identification in a register associated with the first physical port; and
store the logical standby port identification in a register associated with the second physical port.

17. The machine-accessible medium of claim 15, wherein when executed by the machine further causes the machine to:
receive, upon detection of a fault on the first physical port, the logically active port identification at the second physical port, the logical standby port identification at the first physical port, and a switch-over command; and
utilize, upon completion of a switch-over, the first set of threads to receive and reassemble data packets received from the second physical port, and the second set of threads to receive and reassemble control packets received from the first physical port.

18. A system comprising
a network processor including
a packet receive controller to allocate a first set of threads associated with a logically active port and a second set of threads associated with a logical standby port; to associate a first physical port with the logically active port and a second physical port with the logical standby port; and to monitor status of the first and the second physical ports; and
a packet receive processor to receive from the packet receive controller a logically active port identification for the first physical port and a logical standby port identification for the second port identification; and to utilize the first set of threads to receive and reassemble data packets received from the first physical port and the second set of threads to receive and reassemble control packets received from the second physical port; and
dynamic random access memory to store data in queues responsive to said network processor.

19. The system of claim 18, wherein when the packet receive controller detects a fault in the first physical port the packet receive controller associates the first physical port with the logical standby port and the second physical port with the logically active port; and issues a switch-over command.

20. The system of claim 18, wherein when the packet receive controller detects a fault in the first physical port the packet receive processor receives the logically active port identification for the second physical port, the logical standby port identification for the first physical port, and the switch-over command; and utilizes, upon completion of a switch-over, the first set of threads to receive and reassemble data packets received from the second physical port, and the second set of threads to receive and reassemble control packets received from the first physical port.
